(19) United States
(12) Patent Application Publication
(10) Pub. No.: US 2016/0244346 A1
(43) Pub. Date: Aug. 25, 2016

(54) BLOWDOWN RECYCLE METHOD AND SYSTEM FOR INCREASING RECYCLE AND WATER RECOVERY PERCENTAGES FOR STEAM GENERATION UNITS

(71) Applicant: HUSKY OIL OPERATIONS LIMITED, Calgary (CA)

(72) Inventors: Rodger Francesco Bernar, Calgary (CA); Sheldon Douglas, Calgary (CA)

(21) Appl. No.: 15/030,137

(22) PCT Filed: Oct. 17, 2014
(86) PCT No.: PCT/CA2014/000746

§ 371 Date: Apr. 18, 2016

Related U.S. Application Data
(60) Provisional application No. 61/892,810, filed on Oct. 18, 2013.

(51) Int. Cl. C02F 1/72; E21B 43/24; C02F 1/02; E21B 43/40

(52) U.S. Cl. CPC C02F 1/727; E21B 43/40; E21B 43/2406; C02F 1/02; C02F 2101/10

(57) ABSTRACT

A boiler blowdown recycle method and system for increasing recycle and water recovery percentages for steam generation units used in thermal hydrocarbon recovery processes such as SAGD and CSS methods. Blowdown from a steam generating unit is elevated to supercritical temperatures and pressures, and an oxidizing agent added, thereby oxidizing organic and inorganic compounds in the blowdown and simultaneously reducing solubility of inorganics within the blowdown allowing them to precipitate out or be more easily separated therefrom, leaving a purified stream.

### FIELD OF THE INVENTION

The present invention relates to a method for treating blowdown produced by steam generation units used in steam-assisted gravity drainage or cyclic steam stimulation bitumen production operations, which allows for greater recycling/recovery of water (and thereby reduces disposal quantities and costs), and to a system for generating steam for use in SAGD and CSS bitumen production operations.

### BACKGROUND OF THE INVENTION AND DESCRIPTION OF THE PRIOR ART

In steam-assisted gravity drainage (SAGD) and cyclic steam stimulation (CSS) hydrocarbon recovery operations, steam is generated at surface by steam generation units and injected downhole into a well, where it is subsequently introduced into an underground hydrocarbon formation in which such well lies, after which such steam warms bitumen and oil within such formation. Thus-warmed hydrocarbon within the formation is mobilized and moves or is drawn toward the well, where it is then collected and produced to surface. The steam, when contacting cooler subterranean bitumen and oil, typically condenses to water, releasing latent heat of condensation and thereby effectively transferring heat to the oil/bitumen.

Due to the foregoing condensation of injected steam to water, and by reason that underground formations typically contain amounts of water in form of brine or the like, water is typically produced to surface with the recovered oil. Because proximate sources of water for producing steam for injection downhole are often in very short supply, or their use prevented due to governmental restrictions, it is very desirable to use produced water to generate steam. Not only is such water (although contaminated) available at site, by generating steam from such produced water disposal costs of such contaminated produced water is reduced.

A free water knock out (FWKO) vessel is conventionally used at surface to separate the recovered hydrocarbons from the produced water, and the produced water is thereafter recycled to the steam generation unit for re-use in converting same to steam for injection downhole, but typically the produced water contains significant impurities in the form of quantities of hydrocarbons and inorganic compounds, such as calcium and magnesium ions, which are present in “hard” produced water and brines.

Conventional drum boilers operating at 100% steam quality cannot typically be used to generate steam from the produced water without the use of evaporators to generate high purity feed water due to the concentration of dissolved salts and impurities such as calcium, silica, organics and the like that cause precipitation and thereby scaling within boiler tubes during the boiling of the water, which thereby very quickly renders the boiler ineffective in transferring heat to the water to generate steam and can also rupture boiler tubes due to the generation of hot spots.

Alternatively, special types of steam generators are used, namely so-called “Once-Through Steam Generators” (hereinafter “OTSG” or “OTSGs”), which can better handle higher amounts of impurities in the produced water feed stream and generate steam ranging from 65% to 90% steam quality (65-90 parts steam vapor, 10-35 parts water containing the impurities). Operating at this steam quality greatly reduces the dissolved salts which precipitate and scale the tubes. Nevertheless, produced water pre-conditioning steps are still necessary, such as the warm lime softening (“WLS”) or hot lime softening (“HLS”) process, which injects lime to reduce water hardness and alkalinity and precipitates silica and carbonate ions out of the water, and in conjunction with a Weak Acid Cation or Strong Acid Cation ion exchange (“WACS” or “SACS”) process, removes the calcium and magnesium scale generating ions to acceptable concentrations, thereby reducing build-up of scale in the OTSG. The major bulk chemicals used in these processes are lime (Ca(OH)₂), magnesium oxide (MgO), soda ash (Na₂CO₃), caustic (NaOH), and hydrochloric acid (HCl). Several of these chemicals are in solid form requiring silos and mixing systems to inject the chemical into the process. Minor amounts of coagulant and polymer are used to aid in solid separation.

As both of the aforementioned lime softening and ion exchange feedwater pre-conditioning systems are well known and used extensively in industry, particulars of such processes are not discussed further herein.

Likewise often employed as a boiler feedwater pre-conditioning apparatus is a de-oxygenator. Such de-oxygenator, of a type well known to persons of skill in the art, substantially reduces the concentration of oxygen in the feedwater, as the presence of oxygen (an oxidizing agent) in boiler feedwater is acknowledged by persons of skill in the art as detrimental in that it assists in the corrosion of boiler components and reduction of boiler tube life. Oxygen in boiler feedwater may also detrimentally assist, depending on feedwater makeup and composition and which inorganic compounds are present, in the precipitation of substances within heating tubes which detrimentally reduce the imparting of heat to the water being heated and thus detrimentally affect the efficiency of the steam generator in generating steam.

OTSGs produce up to 90% steam quality (i.e. 90 parts steam vapor, 10 parts liquid water). However, in SAGD operations, typically a 100% steam quality is desirable, and accordingly vapour separators will be used at surface to upgrade the steam quality to 100% prior to injection of the 100% steam downhole. In CSS operations, 65% quality steam can be directly injected.

Conventional treatment of produced water using an OTSG produces a blowdown water stream, which is between 10 and 35% of the boiler feedwater volume and results in a brine stream (high in dissolved solids) which has between 3 and 10 times the concentration of impurities in the boiler feedwater. Some of this blowdown is desirably recycled to the feedwater conditioning system to conserve water, but the amount recycled is limited by the maximum levels of impurities that can be tolerated in the OTSG. The balance of the blowdown that is not recycled is conventionally disposed of in disposal wells, and results in a high degree of freshwater or groundwater demand.

Recycling such saline blowdown back into the OTSG feedwater increases the total dissolved solids (“TDS”) being handled by the OTSG boiler, and continued recycling thereby causes an absolute limit to be quickly reached for the OTSG boilers (approximately 8000 mg/L of TDS), beyond which unacceptable fouling of the boiler will result making the boiler inefficient and ineffective in generating steam and could result in tube overheating and catastrophic tube failures if the scale buildup is not controlled via frequent mechanical removal procedures such as pigging.

Accordingly, due to unacceptably high TDS, silica and fouling organics in the feedwater which result from too high a percentage of blowdown recycle in the boiler feedwater, approximately 10% of the boiler feedwater ends up being disposed of in conventional OTSG steam generation systems. Specifically, the highly alkaline boiler blowdown is typically dealt with in one of two ways, namely: a) the alkalinity and pH is reduced to neutral by the injection of acid, and then passed through a filter to filter out wet solids which are taken to a landfill, and the remaining liquid disposed of by injection into a deep well; or b) if governmental regulations limit or reject disposal wells, the operator must deploy low-liquid discharge (“LLD”) or zero-liquid discharge (“ZLD”) technology where the blowdown is converted to dry waste, by passing through an evaporator, a crystallizer, and subsequently the wet solids are converted to dry solids via a kiln (dryer), wherein the resulting dry solid waste is thereafter transported to a landfill. One company which currently has a ZLD system is Suncor Energy Inc., at its McKay River facility near Fort McMurray, Alberta, Canada.

Evaporators of the so-called mechanical vapour compression (“MVC”) or “falling film” type have been used instead of, or to supplant, the WLS and WACS when recycling boiler blowdown and attempting to recover/re-use as much of the water therein as possible. One company which currently additionally uses evaporators to treat boiler blowdown and increase the water therefrom which is capable of being recycled is Suncor Energy Inc., at its Firebag Stage 2 facility near Fort McMurray, Alberta, Canada.

Use of evaporators are viewed as an improvement on the WLS and WACS treatment systems to reduce water demand and disposal needs, but they suffer from high capital and power costs and an increased greenhouse gas footprint due to the related power demand.

Nonetheless, evaporators are still not able to recover for re-use a significant portion of the water in the blowdown unless accompanied by crystallizers and kilns (the ZLD system). Again, while some of the water in the blowdown is recovered through use of the evaporator, a significant percentage of such blowdown is typically nonetheless disposed of, in accordance with one or other of the above-mentioned disposal methods, resulting in permanent loss of water, which is thus unavailable for generation of steam.

Accordingly, a real need exists in the SAGD and CSS hydrocarbon recovery processes for a new relatively low capital and low operating cost method and system which allows for increased use of boiler blowdown as feedwater, so as to reduce the need for additional fresh water in such SAGD and CSS processes, and to simultaneously thereby reduce disposal costs which otherwise result in having to dispose of such boiler blowdown.

### SUMMARY OF THE INVENTION

The present invention uses oxidation of boiler blowdown at temperatures exceeding 374° C. and pressures exceeding 22 mPa. Specifically, an oxidizing agent reacts with the blowdown impurities at temperatures and pressures when the water therein is in a supercritical fluid state, namely when it is neither in a liquid nor a gas form, which can be readily achieved in a OTSG SAGD or CSS hydrocarbon recovery operation due to the starting temperatures and pressures. This method possesses certain real advantages over evaporation or ZLD systems. Specifically, when water is heated above the critical point into supercritical conditions, the static dielectric constant and the density of water decrease significantly. As a result, the solvent polarity and solubility characteristics of supercritical water are reversed compared to those features of water at ambient conditions. Organic compounds become more soluble in super critical water, while inorganic compounds become insoluble. This allows supercritical water to have special properties which causes almost all inorganics to precipitate out and dissolves all organics; oxidation at this state then converts all dissolved organics to carbon dioxide and all inorganics to oxides for removal, and thus acts to purify the water and enables a high degree of recycle. This, to the applicant's knowledge, has never been done in SAGD or CSS hydrocarbon recovery operations.

OTSG blowdown is typically at approximately 300° C. and 7 mPA before it is cooled and depressurized for recycle or disposal. The amount of additional energy to convert the blowdown to a supercritical state of 374° C. and 22 mPA is approximately 732 KJ/kg for 300° C. water as opposed to approximately 1950 KJ/kg for disposal water at 30° C., a reduction of 63%. This makes supercritical water oxidation feasible from an energy consumption perspective.

The present invention advantageously and beneficially allows the converting of organic impurities in the OTSG blowdown to principally carbon dioxide and additional water, all of which are desirable when injected downhole, and in the case of CO₂ is miscible in oil and has a desirable diluent effect on oil and decreases the viscosity thereof thereby assisting in the recovery thereof in SAGD and CSS operations. Boiler blowdown is thus able to be recycled and purified feedstock for subsequent production to steam and direct injection downhole, or alternatively to be directly flashed to steam, and to inject downhole such steam along with any created CO₂, N₂, and water by-products of such oxidation.

Use of a supercritical water oxidation process to increase recycle and re-use of a boiler blowdown, particularly where such blowdown or at least a portion thereof is recycled back to a steam generation unit, is counter-intuitive to a person of skill in the art, since oxidizing agents such as oxygen are typically attempted to be removed as much as possible in the boiler feedwater, as it is common knowledge that oxygen in boiler feedwater detrimentally contributes to corrosion of boiler internals and thereby shortens boiler operating life.

Above the thermodynamic critical point of water (374° C. and 22 mPa), polar inorganic compounds such as salts become insoluble. The present invention involves use of a filter or cyclone separator before, during or after the oxidation step to remove the insoluble inorganic compounds. The present invention removes both organic and inorganic compounds in order to meet the strict demands for recycling blowdown in SAGD and CSS processes.

As boiler blowdown contains organic compounds such as higher molecular weight hydrocarbons, which although having boiling points higher than that of water advantageously have high heats of combustion (oxidation), oxidation of same in accordance with the present invention and the resulting exothermic release of heat therefrom requires less additional energy (depending on the quantity of such higher hydrocarbons in such boiler blowdown) to raise the temperature of such blowdown to the desired supercritical temperatures and pressures, since the oxidation of such compounds will further serve to heat the blowdown.

Unlike with steam generation units, the additional heating of the blowdown does not engender fouling of such additional heating equipment, since no steam is per se generated, heat and pressure merely added to the blowdown to achieve supercritical conditions.

Further, the additional heat necessary to elevate the temperature of such blowdown to supercritical temperatures can easily be recovered to heat further boiler feedwater and/or blowdown water emanating from the boiler to supercritical temperatures, to reduce loss of such heat and to improve the economics of carrying out the present invention. Additional steam can also be generated which is advantageous for a SAGD or CSS operation.

While heating such boiler blowdown to supercritical temperatures and pressures would typically lead a person of skill in the art to reject the use of such a process as being prohibitively expensive and complex, since typically, for example, blowdown needs to be heated far in excess of the boiling point of water (100° C.), namely to in excess of 374° C., it has surprisingly been found that there are inherent economies when the present invention is employed as part of a SAGD or a CSS recovery system, such as but not limited to:
(i) the ability to make use of the oxidation products CO₂ and generated water as mentioned above to assist in oil recovery;
(ii) the heat generated in oxidizing higher molecular weight hydrocarbons present in boiler blowdown reduces the heat energy needed in the process;
(iii) the ability to reduce not just amounts of fouling organics contained in the blowdown but also amounts of inorganic impurities introduced in the recycle stream, and thus cut down on expensive lime and additional chemicals used in the WLS system;
(iv) the ability to avoid both the use of evaporators (which generally take up large amounts of space) and the associated power needs to achieve required flow rates;
(v) the ability to easily flash the treated blowdown, when purified, from supercritical conditions to steam and to re-inject same downhole;
(vi) avoiding the expensive cost of blowdown disposal which can typically include the cost of crystallizing and drying such blowdown for subsequent transport to land disposal sites or the cost for pH adjustment, and filtering operations for separating wet solids; and
(vii) the ability to easily use a heat exchanger(s) to recapture heat added to the blowdown to thereby create additional steam;
   All of the above contribute to making methods according to the present invention a practical and valuable improvement to conventional methods.

Accordingly, in a first broad aspect, a method of the present invention comprises a blowdown recycle method for a steam generation unit used in producing steam for use in thermal heavy oil recovery operations, including steam-assisted gravity drainage (SAGD) and/or cyclic steam stimulation (CSS) methods, for removing both organic and inorganic compounds from said blowdown and purifying said blowdown to permit re-use of water in said blowdown for subsequent steam generation and/or injection downhole, comprising the steps of:
(i) receiving blowdown produced by a steam generation unit used in producing steam for SAGD or CSS hydrocarbon recovery operations, and heating and pressurizing said blowdown to a temperature exceeding 374° C. and a pressure exceeding 22 MPa;
(ii) injecting an oxidizing agent into said blowdown and causing oxidation of compounds within said blowdown at said temperature and pressure;
(iii) either before step (ii), at the same time as step (ii), or after step (ii) above, using a filter or separator to remove compounds which at said temperature have become insoluble in said blowdown, from said blowdown;
(iv) re-using said blowdown, as now purified, in a SAGD or CSS hydrocarbon recovery process, by one of:
   (a) re-injecting said blowdown into said steam generation unit, and subsequently injecting steam generated therefrom downhole; or
   (b) reducing pressure thereon to cause said water therein to flash to steam, and combining said steam with steam produced by said steam generation unit to form a combined steam and injecting said combined steam downhole.

In a further refinement of the aforesaid method, step (iv)(b) is carried out further comprising the additional step of re-injecting unflashed blowdown into said steam generation unit, and subsequently injecting steam generated therefrom downhole.

In a still-further refinement of the above broad method, such method further comprises the step, after completion of step (ii), of removing any remaining of said oxidizing agent from said blowdown by adding a reducing agent to said blowdown, so as to produce a purified stream containing little oxidizing agents, for subsequent re-supply to said steam generation unit for use in said SAGD or CSS hydrocarbon recovery process, or adjusting the oxidizing agent injection to sub-stoichiometric quantities to avoid the potential of oxygen entering the system or the need for the addition of anti-oxidants.

In a further refinement of the above broad method or in combination with such above refinement, such method further comprises the step, after step (ii), of utilizing the products of said oxidation of said organic compounds and injecting said products downhole to improve hydrocarbon recovery.

In a still further refinement of the above broad method or in combination with the above refinements, said step of using a filter or cyclone separator to remove the inorganic compounds from said blowdown is conducted at the same time as step (ii) or after step (ii).

In a still further refinement of the above broad method or in combination with the above refinements, the method further comprises the steps of:
subsequent to step (ii), reducing pressure of said resultant blowdown, and
combining steam which is liberated as a result of said reduction in pressure with said steam produced by said steam generation unit to form a combined steam, and injecting said combined steam downhole in said SAGD or CSS hydrocarbon recovery process.

To reduce needed energy requirements, the method may further comprise the step, after step (ii), of directing said blowdown resulting after step (ii) through a heat exchanger, wherein heat contained in said blowdown due to said heating and/or heat emitted arising from said oxidation of said organic compounds therein, is used to heat incoming blowdown generated by said steam generation unit.

In a further refinement, the method optionally may further comprise the step, prior to step (ii), of injecting one or more additional oxidizable organic compounds into said blowdown, so as to cause, when carrying out step (ii), oxidation of said additional oxidizable organic compounds and liberation of additional heat so as to increase temperature of said blowdown, after injection of said oxidizing agent and during oxidation of said organic compounds therein, to a temperature exceeding 374° C.

In a still-further refinement, the oxidizing agent added to the blowdown is oxygen, although other oxidizing agents may easily be used, such as hydrogen peroxide, air, and other oxidative compounds well known to persons of skill in the art, although oxygen remains, due to its cost and lack of additional inert gases, the preferred oxidizing agent.

Where the oxidizing agent is oxygen which is injected into the blowdown prior to achieving, or at supercritical temperatures and pressures, the blowdown is subsequently subjected to a de-oxygenation step to remove unreacted oxygen, and thereafter re-injected into the steam generation unit and subsequently injecting steam generated therefrom downhole. De-oxygenation processes are well known to persons of skill in the art, and may comprise the addition of hydrazine, or sodium bisulphite, to remove oxygen from the treated blowdown.

The above method may be used in combination with a one or more of traditional treatment systems, including:
(a) a warm lime softening system;
(b) a weak acid cation or strong acid cation ion exchange system;
(c) a ceramic membrane deoiling and/or desilication system; and
(d) an evaporator;
   as a polishing system for the blowdown treatment.

In a further broad aspect of the invention, the invention relates to a blowdown recycle system for removing compounds, including organic and inorganic compounds, from blowdown generated by a steam generation unit used in SAGD and CSS hydrocarbon recovery processes to purify said blowdown to permit re-use of water therein up to 100%, comprising:
(i) a steam generation unit, which generates blowdown which contains water and both inorganic and inorganic compounds;
(ii) a pump and a heat source for raising the pressure and temperature of said blowdown, to temperatures and pressures exceeding 374° C. and 22 MPa, respectively;
(iii) reactor apparatus, for injecting an oxidizing agent into said blowdown and causing oxidation of said organic compounds within said blowdown at temperatures and pressures exceeding 374° C. and 22 MPa, respectively;
(iv) a filter and/or separator device for removing said inorganic compounds from said heated blowdown, at a temperature and pressure exceeding 374° C. and a pressure exceeding 22 MPa; and
(v) a pressure-reduction apparatus for dropping pressure of said blowdown and flashing water therein to steam.

A heat exchanging system for recapturing heat added to the blowdown may optionally be added.

A port is preferentially provided on piping containing such blowdown, downstream from a port provided to allow introduction of the oxidizing agent, for allowing introduction of a reducing agent into the blowdown stream for eliminating remaining unreacted portions of said oxidizing agent in said blowdown, when the blowdown is recycled back to the steam generation unit feedwater for re-introduction into the steam generation unit for conversion to steam.

In preferred embodiments the separator device used for separating the inorganic materials from the supercritically heated blowdown (at which temperatures and conditions the solubility thereof is greatly reduced) is a mechanical device such as a cyclone separator. Other types of filters, such as sintered metal screens or ceramics capable of withstanding temperatures in the range of 400-600° C., may alternatively be used.

Likewise, as in the method, the system as described above may further comprise one or more of:
(a) a warm lime softening system;
(b) a weak acid cation or strong acid cation ion exchange system;
(c) a ceramic membrane deoiling and/or desilication system; and
(d) an evaporator.

Inorganic materials which remain un-oxidized may subsequently be disposed of in disposal wells, or if not permitted, may be disposed of in landfills, but no water will be included or lost due to having been recycled and re-used in the manner indicated above. Where the method includes pre-treating boiler feedwater with a warm lime softening system, the inorganic materials which typically remain are usually only solids that contain silica, calcium magnesium, and sodium chloride.

### BRIEF DESCRIPTION OF THE DRAWINGS

FIG. 1 is a schematic view of a prior art boiler pre-treatment and recycle system for heating produced water in a SAGD system, showing alternative means (a) and (b) of disposing of boiler blowdown which is not recycled;

FIG. 2 is a schematic view of one embodiment of the recycle method and system of the present invention, for increasing recycle and water recovery percentages for steam generation units;

FIG. 3 is a schematic view of another embodiment of the recycle method and system of the present invention, for increasing recycle and water recovery percentages for steam generation units;

FIG. 4 is a schematic view of another embodiment of the recycle method and system of the present invention, for increasing recycle and water recovery percentages for steam generation units;

FIG. 5 is a schematic view of another embodiment of the recycle method and system of the present invention, for increasing recycle and water recovery percentages for steam generation units;

FIG. 6 is a schematic view of another embodiment of the recycle method and system of the present invention, for increasing recycle and water recovery percentages for steam generation units;

FIG. 7 is a schematic view of another embodiment of the recycle method and system of the present invention, for increasing recycle and water recovery percentages for steam generation units; and

FIG. 8 is a schematic view of another embodiment of the recycle method and system of the present invention, for increasing recycle and water recovery percentages for steam generation units.

### DETAILED DESCRIPTION OF PREFERRED EMBODIMENTS

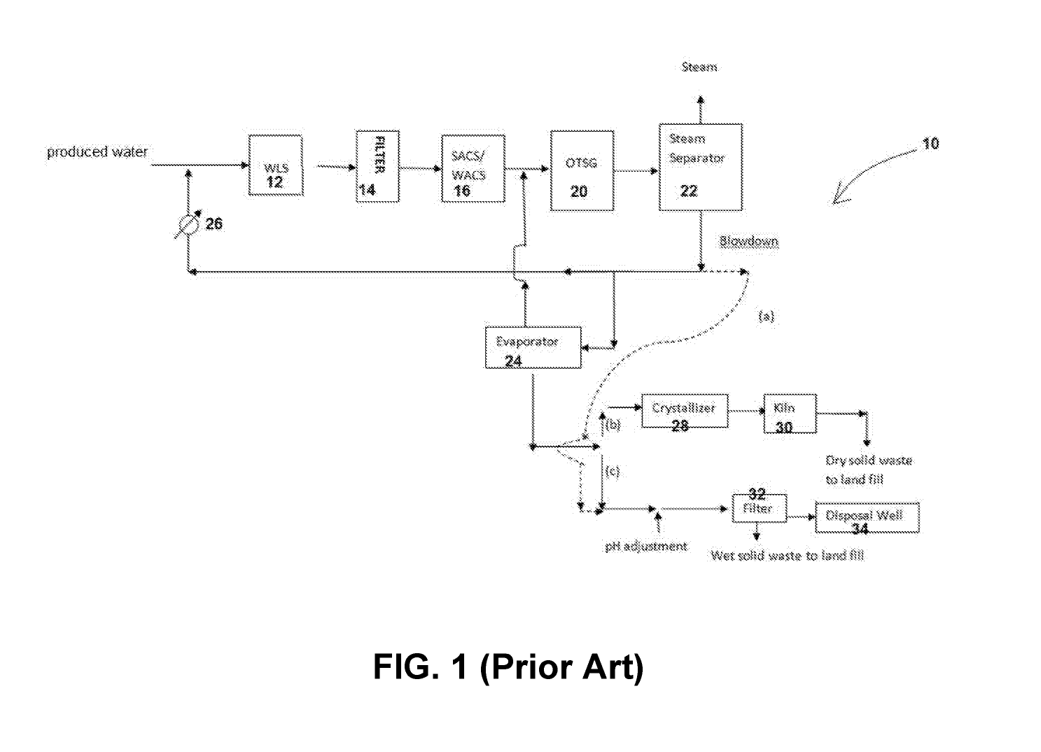

FIG. 1 shows a typical prior art system 10 used for supplying steam to a SAGD or CSS bitumen recovery operation, and the manner and apparatus for dealing with blowdown provided by an OTSG 20.

OTSGs are typically used as the steam generation unit in SAGD and CSS bitumen recovery operations, and are provided with produced water which contains both non-organic compounds and organic compounds.

Specifically, the prior art system 10 shows the typical process for re-using produced water in a SAGD or CSS recovery operation, which produced water results from water which has been separated from previously-recovered hydrocarbons and is attempted to be re-used. Such produced water may (or may not) be blended or combined with fresh water, if a supply thereof is available and regulations permit its use, to produce a supply of water, albeit containing inorganic and organic contaminants, for supply to the OTSG 20.

Commencing from the top left corner of FIG. 1, the produced water stream has combined with it recycled blowdown water received from an OTSG 20 and steam separator 22. Such combined stream is thereafter typically heated via input of heat 26 to provide heat for the subsequent WLS treatment 12. In the WLS treatment step 12 lime is added to the warmed stream, in a manner well known to persons of skill in the art, to precipitate out and reduce solubility of minerals contained in the produced water. The combined flow is thereafter passed through a filter 14 to filter out solids which have become less soluble in the combined stream. Thereafter the stream is subjected to a SACS/WACS treatment 16, and such flow may thereafter have further added to it vapour from an evaporator 24. The resulting combined flow is then directly passed to an inlet of the OTSG 20. Typically a steam separator 22 will be further employed to separate the steam from water (i.e. blowdown) at the output from the OTSG 20.

The produced steam provided by the OTSG 20 is used directly in the SAGD or CSS operation. As to the blowdown from OTSG 20, a portion of the blowdown is recycled and combined with the produced water, as above described. Other remaining portions of the blowdown may further be passed, as shown in route (a) in FIG. 1, to the evaporator 24 if an evaporator is provided, in which case the vapour component thereof exiting the evaporator 24 is again introduced to the inlet of the OTSG 20, as described above. Remaining blowdown and/or liquids remaining from the evaporator 24 if an evaporator 24 is provided, is typically then dealt with in one of two ways (b) or (c), depending on governmental regulations in place, and disposed of.

Disposal route (b) involves passing the blowdown through a crystallizer 28, and subsequently through a high temperature kiln 30 where such blowdown is essentially baked, and the residual resulting solids then transported to a landfill.

Disposal route (c) involves further pH adjustment of the blowdown, by adding an acid or a base to render the resultant product of more neutral pH, and subsequently passed through a filer 32, where wet solid waste is then transported to landfill, and any liquid waste is thereafter pumped down a disposal well. As shown by the dotted line, blowdown can be routed directly to this pH adjustment operation, bypassing the evaporator.

Disadvantageously, however, such prior art system 10 achieves poor rates of blowdown recycle. This is due to the fact that too high an amount of blowdown recycle increases fouling of heating tubes in the OTSG 20, and may lead to heating tube rupture in the OTSG 20 due to creating of “hot spots” which arise in the tubing due to non-uniform mineral deposition on boiler tubes and uneven heating or plugging of such tubes. The percentage of blowdown which may be recycled by combination with produced water is further limited due to the impurities likewise existing in the produced water stream, with which the blowdown is combined. Accordingly, such prior art system and method relies heavily on disposal routes (b) or (c) for disposing of boiler blowdown, and thereby reduces the amount of water which may be recycled, and further disadvantageously requires higher amounts of produced water and/or additional quantities of blended fresh water, which may or may not be available.

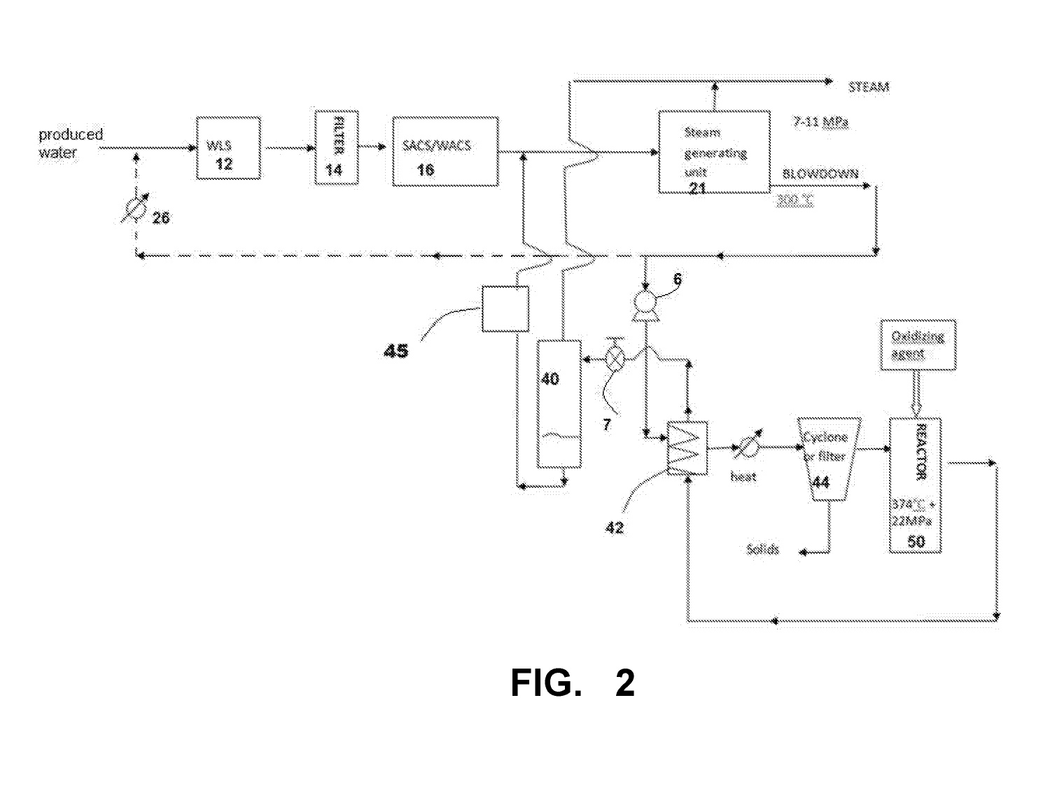

In direct contrast to prior art methods, FIGS. 2-8 herein illustrate various embodiments of methods and systems according to the present invention, which allows substantially greater recycle of boiler blowdown and greater conversion to steam of produced water, as well as longer OTSG boiler life, and eliminated or greatly reduced freshwater demands.

The method and system of the present invention makes use of the fact that in water at supercritical temperatures and pressures (374° C. and 22 MPa, respectively), the solubility of organics such as hydrocarbons and other fouling organics that are invariably entrained in produced water is greatly increased, whereas conversely, the solubility of inorganic compounds is substantially reduced.

Advantageously, by application of temperature and pressure to boiler blowdown so as to cause water therein to achieve supercritical conditions, combined with the step of addition of an oxidizing agent, such as oxygen, which can be added before, during, or after the subjugation of the blowdown to supercritical temperatures and pressures, not only are the problematic inorganics present in such boiler blowdown (which are largely responsible for mineral deposits on boiler heating tubes) substantially rendered insoluble upon such blowdown reaching such supercritical conditions, but further, organics entrained in the water, now made completely soluble in the water due to supercritical conditions, and no longer in an immiscible form and can now be better and substantially oxidized upon exposure, at such supercritical temperatures and pressures, to an oxidizing agent such as air, thereby leaving the resultant water with reduced impurities.

FIG. 2 illustrates a first embodiment of one method and apparatus of the present invention, where a steam generating unit 21 (typically an OTSG 20) and a steam separator 22 (as shown in FIG. 1) is used to produce the needed steam.

In such embodiment, produced water is, as in the prior art, subjected to WLS treatment 12, passed through a filter 14, and may in addition, or in the alternative, be exposed to a SACS or WACS 16 to reduce impurities in the steam generating unit 21 feedwater. After passing through the steam generating unit 21 where a portion of the blowdown is turned to steam, the remaining boiler blowdown portion of such blowdown may be recycled back for repeated treatment in the above manner (see dotted lines of FIG. 2), after addition of heat 26 thereto. Alternatively, not only some but all of the boiler blowdown may be dealt with in the manner of the present invention as follows. Specifically, the non-recycled blowdown is first raised to a pressure of or exceeding 22 MPa via a pump means 6. Thereafter such blowdown stream is passed through a heat exchange 42 to raise the temperature thereof, and further heat is applied to raise the temperature to supercritical conditions (≧374° C.). The heated blowdown, now containing water in a supercritical state, is further passed through a filter, such as a sintered and/or ceramic filter capable of withstanding such high temperatures or alternatively passed through a centrifugal separator such as a cyclone separator 44, to remove precipitated inorganic solids now rendered at such temperatures and pressures substantially insoluble. Thereafter, an oxidizing agent, such as oxygen, air, hydrogen peroxide, or the like, is added to the blowdown, to thereby oxidize the organic (i.e. carbon-containing) compounds, particularly hydrocarbons in the blowdown, converting same to carbon dioxide and water. The benefit of oxidizing such carbon-containing compounds to water has the further added benefit in producing, as a by-product of the oxidation process, additional water.

Thereafter, such blowdown, containing further water (i.e. steam) as a by-product of the oxidation process, but having organic and inorganic compounds substantially removed therefrom, is passed back through heat exchanger 42 to recover some of the heat therefrom, passed through a valve 7 to drop the pressure from 22 MPa to pressures normally experienced in OTSGs (i.e. 7-11 MPa), and passed through a steam separator device 40 to separate steam from the remaining blowdown. The steam is subsequently supplied for use in SAGD or CSS operations. The remaining water is passed through a de-oxygenator device 45, of a type commonly used in the art, to remove oxygen therefrom which would otherwise cause increased corrosion of piping within steam generating unit 21. The de-oxygenated flow is then recycled and re-supplied to steam generation unit 21 for use in supplying additional quantities of steam.

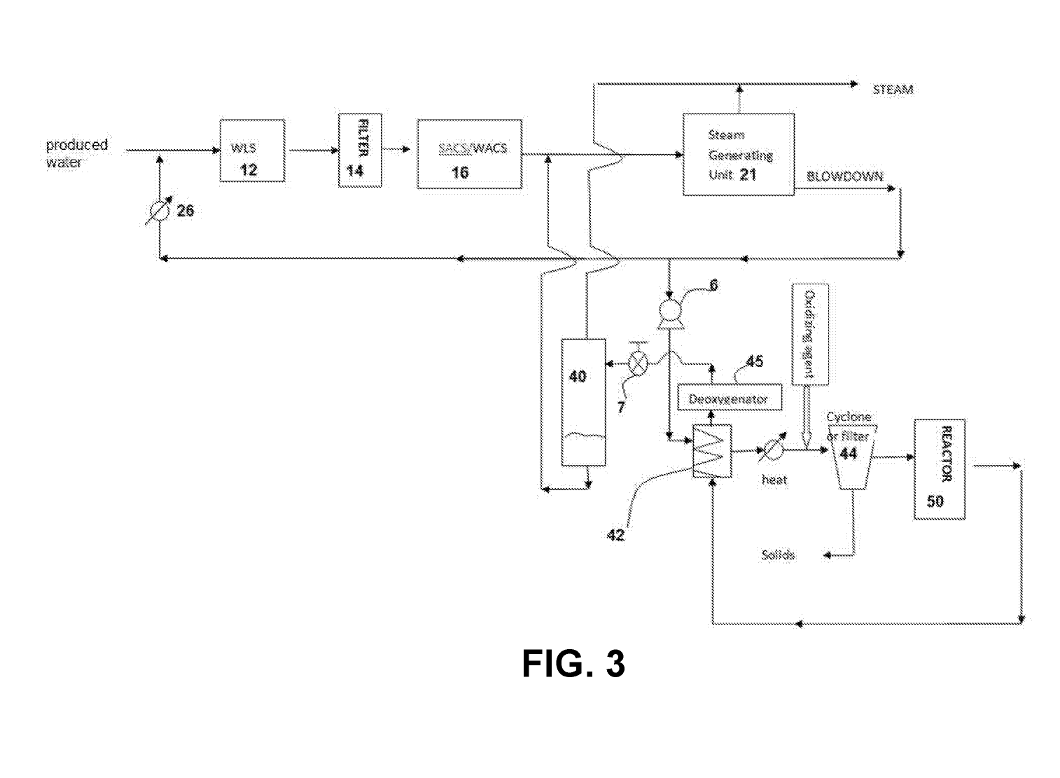

FIG. 3 illustrates another embodiment of the invention. The system of FIG. 3 differs from FIG. 2, in that the oxidizing step occurs prior to the filtering step 44, and immediately after the flow of the blowdown through the heat exchanger 42 and the subsequent further application of heat. In addition, the de-oxygenation step 45 occurs after the steps involving the reactor 50 and the heat exchanger 42 but prior to pressure reduction via valve 7 and the blowdown passing into the steam separator 40. The de-oxygenation via de-oxygenator 45 may occur at any point in the process subsequent to the oxygenation step, but prior to re-introduction/re-cycling of the treated blowdown back to the steam generating unit 21.

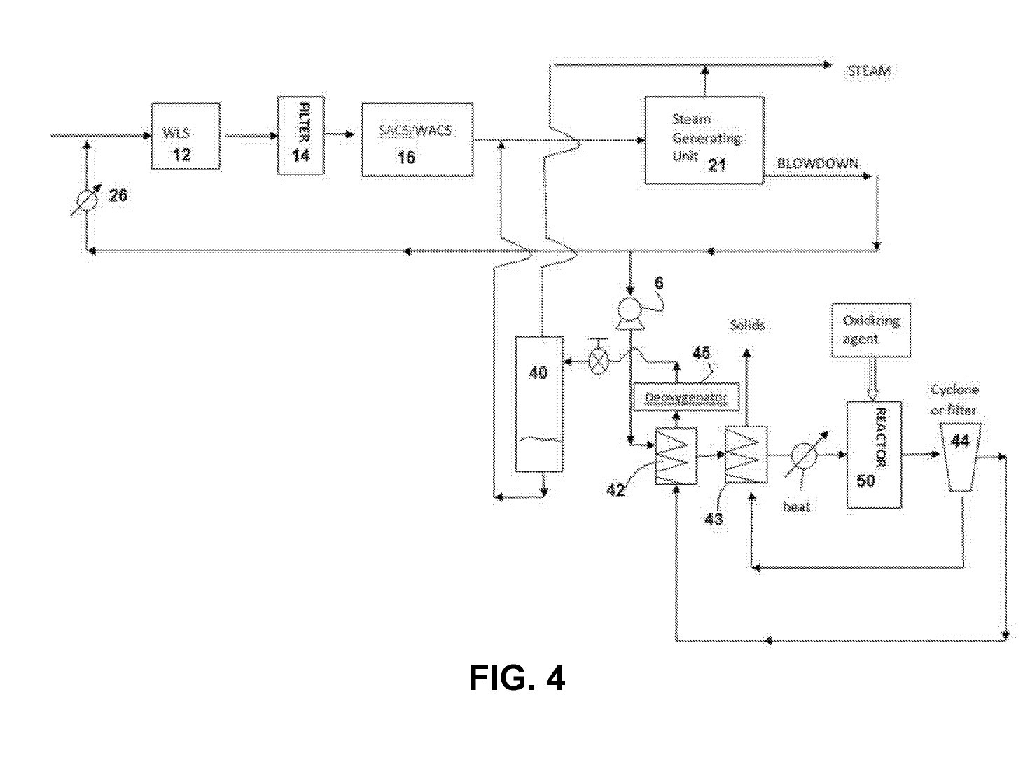

FIG. 4 illustrates yet another permutation of the system and method of the present invention. The system of FIG. 4 differs from the systems of FIGS. 2 & 3, in that the filter or separator 44 is introduced after the oxidizing agent is added and the oxidation has taken place in the reactor 50, and the (heated) solids are thereby removed, and further passed through an additional heat exchanger 43, to recapture heat therefrom and pass such heat into the blowdown stream passing to the reactor 50.

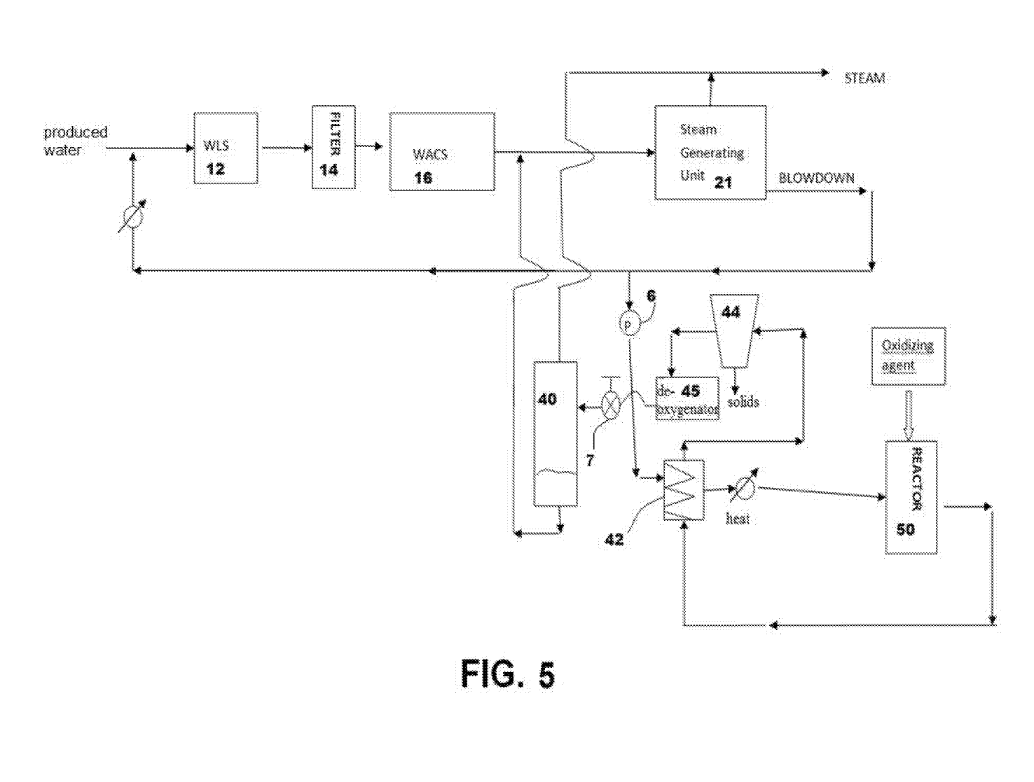

FIG. 5 illustrates yet another permutation of the system and method of the present invention. Such system/method depicted therein differs from that shown in FIG. 4, in that the filter/separation step 44 is only carried out after the blowdown has had oxidizing agent added thereto and has passed through the reactor 50 (after the organic material has been oxidized). Such method may in some circumstances be less preferable than the method of FIG. 4, since it is desired to carry out the filtering (using separator/filter 44) at supercritical conditions where inorganic materials are highly insoluble, but it may be necessary as an inexpensive alternative where filtering needs to be carried out at lower temperatures (temperatures lower than 374° C.), and after passing through the heat exchanger 42, where the temperature of the blowdown may then be more bearable for the filters to be able to reliably operate. Alternatively, such system is preferable to that in FIG. 4 where the heat liberated from the oxidation step in reactor 50 raises the temperature of the blowdown far in excess of 374° C., and even with passing the oxidized blowdown through the heat exchanger 42 the resultant temperature is still in or near supercritical range where the inorganics possess low solubility and may still be effectively filtered.

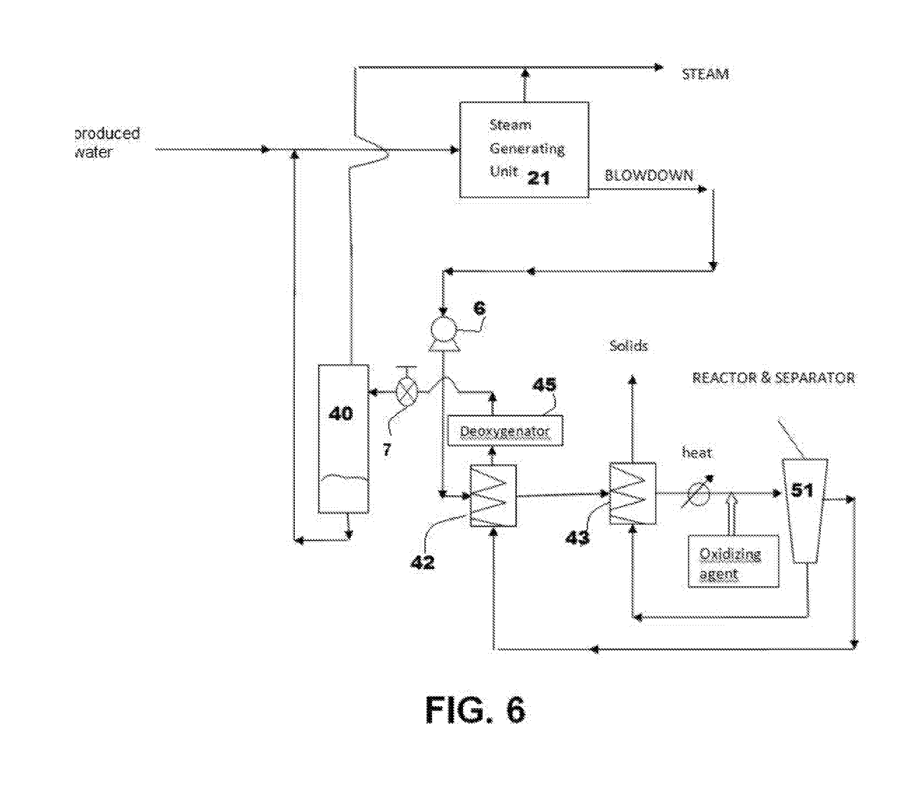

FIG. 6 illustrates a further permutation of the system/method of the present invention, differing in that the reactor 50 and separator 44 are combined into a single step/apparatus, namely reactor/separator 51. Again, a heat exchanger 42 is used to recover heat from liquid blowdown separated in the reactor/separator 51, and a further heat exchanger 43 is used to recover heat from solids separated from in the reactor/separator 51.

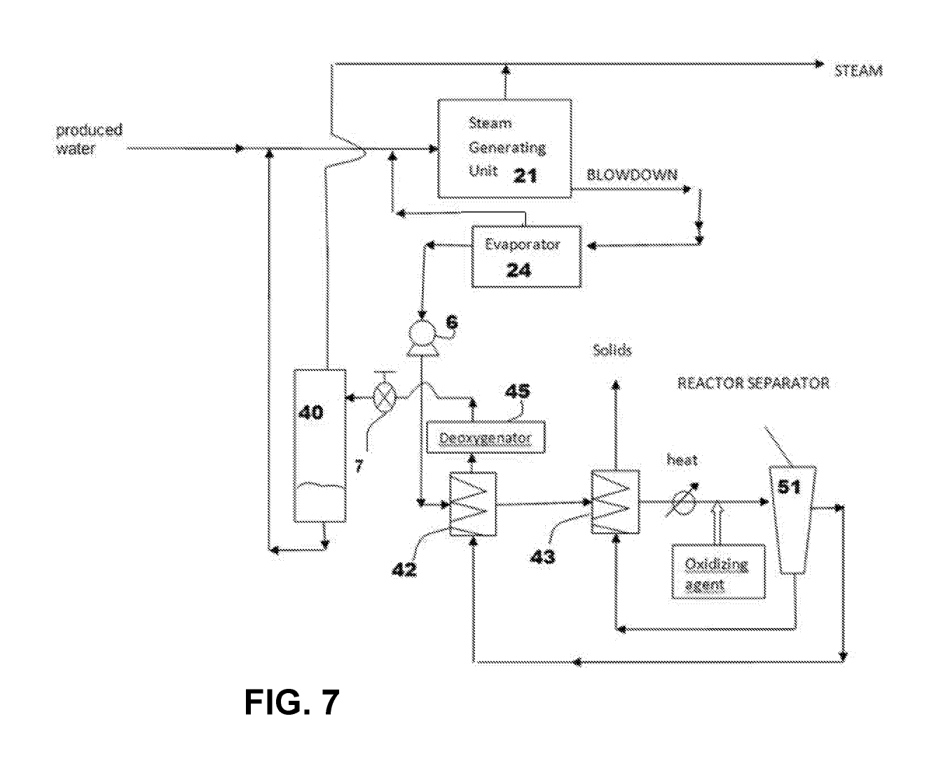

FIG. 7 illustrates yet a further permutation of the system/method of the present invention, differing from that of FIG. 6 in that the blowdown, immediately after exiting the steam generating unit 21, is passed through a further device, namely an evaporator 24, and thereafter remaining blowdown not passed as vapour to the steam generating unit 21 is thereafter passed to pump 6 for further treatment in the manner taught in FIG. 6.

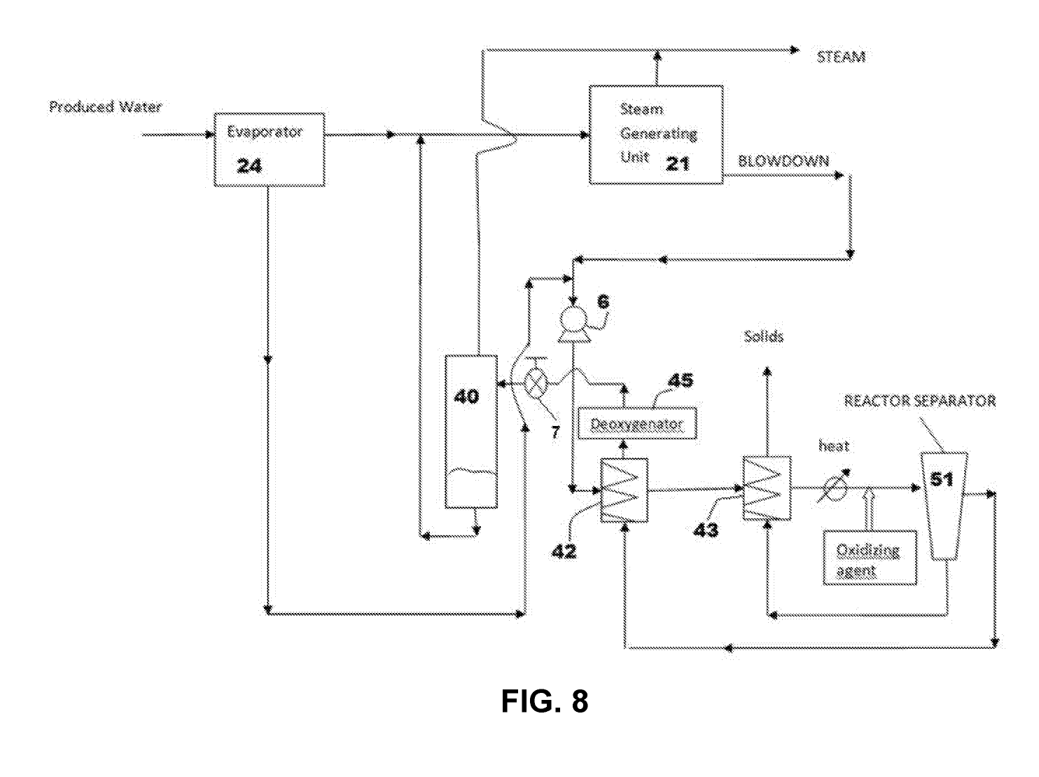

Lastly, FIG. 8 illustrates yet a further permutation of the system/method of the present invention, and differs from the method as shown in FIG. 7, in that the evaporator 24 (and step of evaporation) is carried out immediately on the produced water (as opposed to the boiler blowdown flow), and output therefrom not passed as vapour to the inlet of the steam generating unit 21 is thereafter combined with blowdown from the steam generating unit 21, where thereafter it is subsequently pressurized by pump means 6 to supercritical pressures before being further treated in the manner set forth above and depicted in FIG. 7.

The above disclosure represents embodiments of the invention recited in the claims. In the preceding description, for purposes of explanation, numerous details are set forth in order to provide a thorough understanding of the embodiments of the invention. However, it will be apparent that these and other specific details are not required to be specified herein in order for a person of skill in the art to practice the invention in its various permutations and combinations.

The scope of the claims should not be limited by the preferred embodiments set forth in the foregoing examples, but should be given the broadest interpretation consistent with the description as a whole, and the claims are not to be limited to the preferred or exemplified embodiments of the invention.

1. A method for recycling blowdown from a steam generation unit used in producing steam for thermal hydrocarbon recovery operations, for removing organic and inorganic compounds from the blowdown to permit re-use of the blowdown for subsequent steam generation and/or injection downhole, comprising the steps of:
(i) receiving the blowdown produced by the steam generation unit and heating and pressurizing the blowdown to a temperature exceeding 374° C. and a pressure exceeding 22 MPa;
(ii) injecting an oxidizing agent into the blowdown and causing oxidation of compounds within the blowdown at the temperature and pressure;
(iii) either before step (ii), at the same time as step (ii), or after step (ii), removing from the blowdown the compounds which at the temperature and the pressure have become insoluble in the blowdown; and
(iv) re-using the blowdown in a thermal hydrocarbon recovery process, by one step selected from:
(a) re-injecting the blowdown into the steam generation unit, and subsequently injecting steam generated therefrom downhole; and
(b) reducing pressure on the blowdown to cause water therein to flash to steam, and combining the blowdown-derived steam with steam produced by the steam generation unit to form a combined steam, and injecting the combined steam downhole.

2. The method as claimed in claim 1, wherein step (iv)(b) further comprises the step of re-injecting un-flashed blowdown into the steam generation unit, and subsequently injecting steam generated therefrom downhole.

3. The method as claimed in claim 1, further comprising the step, after completion of step (ii), of removing unreacted oxidizing agent from the blowdown, thereby producing a stream for subsequent re-supply to the steam generation unit.

4. The method as claimed in claim 1, further comprising the step, after step (ii), of injecting one or more of the products of the oxidation of the compounds downhole.

5. The method as claimed in claim 1, wherein said step of removing from the blowdown the compounds which at the temperature and the pressure have become insoluble in the blowdown is achieved using a filter or cyclone separator.

6. The method as claimed in claim 1, further comprising the step of:
subsequent to step (ii), reducing pressure of the blowdown;
allowing liberation therefrom of a liberated steam; and
combining the liberated steam with the steam produced by the steam generation unit to form a combined steam, and injecting the combined steam downhole.

7. The method as claimed in claim 1, further comprising the step, after step (ii), of:
directing the blowdown through a heat exchanger, wherein heat contained in the blowdown is used to heat incoming blowdown generated by the steam generation unit.

8. The method as claimed in claim 1, further comprising the step, prior to step (ii), of injecting one or more additional oxidizable organic compounds into the blowdown, so as to cause, when carrying out step (ii), oxidation of the additional oxidizable organic compounds and liberation of additional heat so as to increase temperature of the blowdown after injection of the oxidizing agent and during oxidation of the organic compounds therein, to a temperature exceeding 374° C.

9. The method as claimed in claim 1, wherein the oxidizing agent is oxygen, and subsequent to injecting the oxidizing agent into the blowdown, subjecting the blowdown to a de-oxygenation step to remove unreacted oxygen, and thereafter re-injecting the blowdown into the steam generation unit, and subsequently injecting steam generated therefrom downhole.

10. A method for recycling blowdown from a steam generation unit used in producing steam for use in thermal hydrocarbon recovery techniques, for removing organic and inorganic compounds from the blowdown to permit re-use of the blowdown, comprising the steps of:
(i) receiving the blowdown produced by the steam generation unit and pressurizing a first portion of the blowdown to a pressure exceeding 22 MPa and heating the first portion to a temperature exceeding 374° C., and subjecting a second portion of the blowdown to one or more treatments selected from:
(a) a warm lime softening system;
(b) a weak acid cation or strong acid cation ion exchange system;
(c) a ceramic membrane deoiling and/or desilication system; and
(d) an evaporator;
and thereafter supplying the second portion to the steam generation unit;
(ii) injecting an oxidizing agent into the first portion of the blowdown and causing oxidation of organic compounds within the first portion;
(iii) removing unreacted oxidizing agent from the first portion of the blowdown, so as to produce a stream;
(iv) before, during or after step (ii), removing inorganic compounds from the first portion; and
(v) re-providing the stream to the steam generation unit.

11. A system for removing organic and inorganic compounds from blowdown generated by a steam generation unit used in thermal hydrocarbon recovery operations to permit re-use of water therein, comprising:
(i) a steam generation unit, which generates blowdown comprising water, organic compounds and inorganic compounds;
(ii) a pump and a heat source, for raising the pressure and temperature of the blowdown to a pressure and temperature exceeding 22 MPa and 374° C., respectively;
(iii) a reactor apparatus, for injecting an oxidizing agent into the blowdown and causing oxidation of the organic compounds within the blowdown at temperatures and pressures exceeding 374° C. and 22 MPa, respectively;
(iv) a solids handling/separating device for removing the inorganic compounds from the blowdown, at a temperature exceeding 374° C. and a pressure exceeding 22 MPa; and
(v) a pressure-reduction apparatus for dropping pressure of the blowdown and flashing water therein to steam.

12. The system as claimed in claim 11, further comprising:
(vi) a heat exchanging system for recapturing heat added to the blowdown.

13. The system as claimed in claim 11, further comprising a port for allowing ingress of a reducing agent and contact of the reducing agent with the blowdown, to react with unreacted portions of the oxidizing agent in the blowdown.

14. The system as claimed in claim 11, wherein the solids handling/separating device is a filter or cyclone separator device.

15. The system as claimed in claim 11, further comprising, in fluid communication with the steam generation unit, one or more of:
(a) a warm lime system;
(b) a weak acid cation or strong acid cation ion exchange system;
(c) a ceramic membrane deoiling and/or desilication system; and
(d) an evaporator;
for treating water produced during the thermal hydrocarbon recovery operations.
